(19) United States
(12) Patent Application Publication
(10) Pub. No.: US 2014/0058718 A1
(43) Pub. Date: Feb. 27, 2014

(54) CROWDSOURCING TRANSLATION SERVICES

(71) Applicants: Anoop Kunchukuttan, Pune (IN); Shourya Roy, Bangalore (IN); Mitesh Khapra, Mumbai (IN); Nicola Cancedda, Grenoble (FR); Pushpak Bhattacharyya, Mumbai (IN)

(72) Inventors: Anoop Kunchukuttan, Pune (IN); Shourya Roy, Bangalore (IN); Mitesh Khapra, Mumbai (IN); Nicola Cancedda, Grenoble (FR); Pushpak Bhattacharyya, Mumbai (IN)

(73) Assignees: INDIAN INSTITUTE OF TECHNOLOGY BOMBAY, Mumbai (IN); XEROX CORPORATION, Norwalk, CT (US)

(21) Appl. No.: 13/592,736

(22) Filed: Aug. 23, 2012

(51) Int. Cl. G06F 17/28

(52) U.S. Cl. 704/2

(57) ABSTRACT

A method, system, and computer program product for translating a text file are disclosed. A text file in a source language is received and text snippets from the text file are extracted. The text snippets are distributed to a first set of remote workers for translation. The translated text snippets are validated by a second set of remote workers and the validated text snippets are used to generate a translated text file.

### COPYRIGHT NOTICE

A portion of the disclosure of this patent document contains material that is subject to copyright protection. The copyright owner has no objection to facsimile reproduction by anyone of the patent document or the patent disclosure as it appears in the Patent and Trademark Office patent file or records but otherwise reserves all copyright rights whatsoever.

### TECHNICAL FIELD

The presently disclosed embodiments are directed to language translation services. More specifically, the disclosed embodiments are directed to crowdsourcing of translation services.

### BACKGROUND

Language translation is usually performed by linguists and language experts. With the advent of computing systems, the use of manual resources for translation purposes has reduced to some extent. Machine Translation (MT) systems relies on a parallel corpora for training purposes. A parallel corpora is a collection of translations of words/phrases/sentences from one language to another. The MT system can be trained to provide real-time translation services after having been trained using a parallel corpora. The development of parallel corpora, however, requires vast resources. Language experts are used to manually develop the parallel corpora which in turn is used train the MT systems. This process is time-consuming, expensive, and may lead to generalization which renders the MT systems inaccurate while dealing with complex sentence translation.

In light of the aforementioned problems, a technique is needed to cost-effectively aid the process of development of parallel corpora for complex sentences.

### SUMMARY

According to aspects illustrated herein, there is provided a method for translating a text file. A plurality of text snippets is extracted from the text file and is distributed to a first set of remote workers for translation. The translated text snippets received from the first set of remote workers are distributed to a second set of remote workers for validation. The validated phrases are combined to generate a translated text file.

According to aspects illustrated herein, there is provided a system for translating a text file. The system comprises a transceiver module for receiving the text file, and a data extraction module for splitting the text file in to sentences, wherein the data extraction module is further configured to extract phrases from the sentences. The system further comprises a task manager for distributing the phrases for translation. The task manager further comprises a job creation module for creating a translation and a validation task, and an aggregator for collecting responses for the translation and validation tasks.

According to aspects illustrated herein, there is provided a computer program product for translating a text file. The computer program product comprises program instruction means for extracting a plurality of phrases from the text file. The computer program product further comprises program instruction means for distributing the plurality of phrases to a first set of remote workers for translation. The computer program product further comprises program instruction means for receiving the translated phrases from the first set of remote workers. The computer program product further comprises program instruction means for distributing the received phrases to a second set of remote workers for validation. Still further, the computer program product comprises program instruction means for generating a translated file by combining the validated phrases.

### BRIEF DESCRIPTION OF DRAWINGS

The accompanying drawings illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

Various embodiments will hereinafter be described in accordance with the appended drawings provided to illustrate and not limit the scope in any manner, wherein like designations denote similar elements, and in which;

FIG. 1 illustrates a system for crowdsourcing translation services in accordance with at least one embodiment;

FIG. 2 illustrates the phrase chunking of a sentence, in accordance with at least one embodiment;

FIG. 3 illustrates components of a task manager, in accordance with at least one embodiment;

FIG. 4 is a snapshot depicting the second task, in accordance with at least one embodiment;

FIG. 5 is a screenshot depicting compilation of the responses for the second task in accordance with at least one embodiment;

FIG. 6 is a screenshot depicting compilation of validated phrases in accordance with at least one embodiment; and

FIG. 7 is a flowchart illustrating a method of crowdsourcing translation services in accordance with at least one embodiment.

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed description given herein with respect to the figures is just for explanatory purposes as the method and the system extend beyond the described embodiments. For example, those skilled in the art will appreciate that, in light of the teachings presented, multiple alternate and suitable approaches can be realized, depending on the needs of a particular application, to implement the functionality of any detail described herein, beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment, though it may.

### DEFINITION OF TERMS

As used in the present specification and claims, however, unless specified to the contrary, the following terms have the meaning indicated.

A “Translation Memory” (TM) refers to a database comprising of sentences or segments of sentences which have previously been translated. According to this disclosure, a TM is a resource located at a service provider. The service provider can use the same to provide translation services to clients.

A “job” or a “task” refers to the work that is completed by remote workers.

A “phrase” refers to a sub-part of a complete sentence. In an embodiment, a phrase is a small group of words which can independently stand as a conceptual unit.

“Crowdsourcing” refers to a technique of outsourcing work to remote workers. In an embodiment, various crowdsourcing platforms such as Amazon Mechanical Turk™, CrowdFlower™, etc., can be used to publish tasks which can be completed by remote workers registered on the crowdsourcing platform.

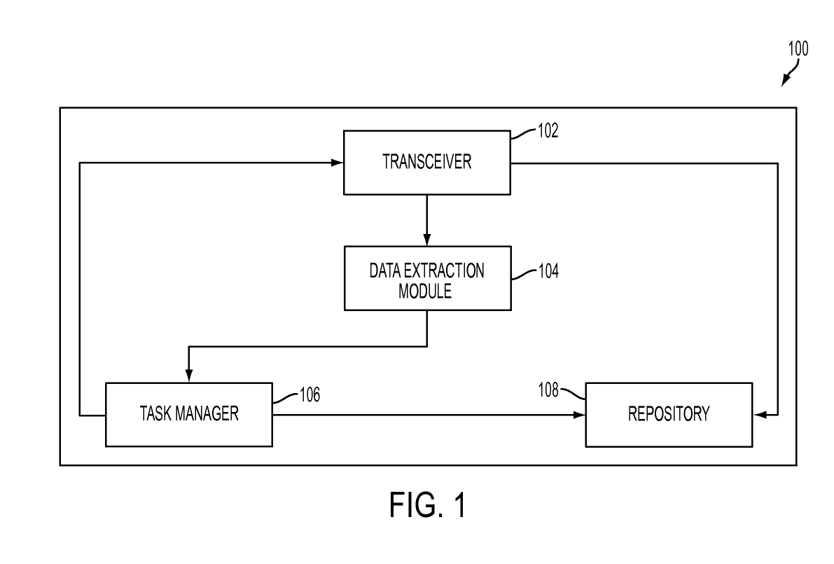

FIG. 1 illustrates a system for crowdsourcing translation services in accordance with at least one embodiment. System 100 comprises a transceiver 102, a data extraction module 104, a task manager 106, and a repository 108.

The transceiver 102 is configured to receive a translation request and send the same to data extraction module 104. Examples of the transceiver module 112 can include, but are not limited to, an antenna, an Ethernet port, an HDMI port, a VGA port, a USB port or any port that can be configured to receive and transmit data from an external source. The transceiver module 112 receives and sends translation request in accordance with various communication protocols such as Transmission Control Protocol and Internet Protocol (TCP/IP), User Datagram Protocol (UDP), 2G, 3G, and 4G.

The data extraction module 104 is configured to determine individual sentences in a text file. Further, data extraction module 104 is also configured to extract phrases from the determined sentences. Data extraction module 104 can be implemented using any known techniques. For example, in an embodiment, a text classifier can be used. It will be understood and appreciated by a person having ordinary skill in the art that any text classifier can be used to implement the data extraction module 104 without departing from the scope of the invention.

The task manager 106 is configured to create and publish jobs/tasks which can be accessed and completed by remote workers. Task manager 106 can publish the task on any known crowdsourcing platform. In an embodiment, task manager 106 is a computing device programmed to create and publish the tasks.

System 100 further comprises a repository 108. Repository 108 is configured to store translated phrases so that they can be re-used without the need to carry out the translation process again. The repository 108 corresponds to a storage device that stores various translated phrases. The repository 108 can be implemented by using several technologies that are well known to those skilled in the art. Some examples of technologies may include, but are not limited to, MySQL®, Microsoft SQL®, etc.

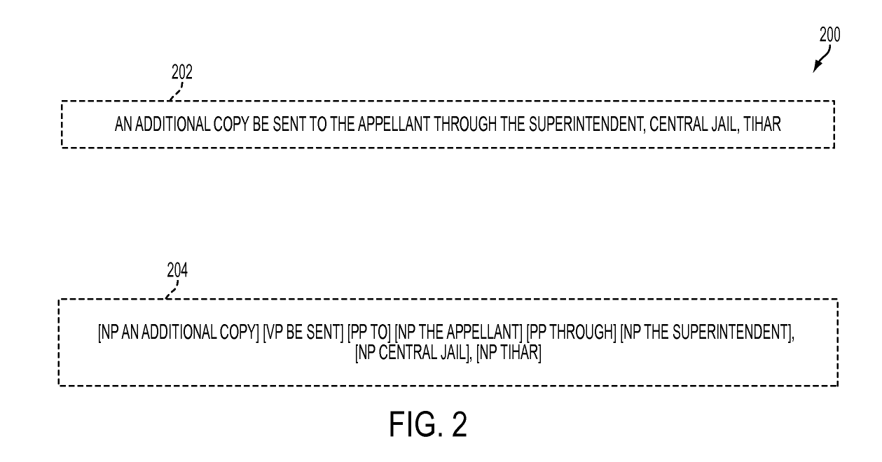

In an embodiment, a requester sends a translation request to the transceiver 102. It will be understood by a person having ordinary skill in the art, that the translation request can comprise a file comprising one sentence, multiple sentence, or multiple paragraphs. The transceiver 102 sends the file to the data extraction module 104. The data extraction module 104 uses the punctuation marks in the file to identify individual sentences. In an embodiment, the data extraction module 104 is programmed to recognize various punctuation marks such as commas, full-stops, exclamations etc in order to recognize the exact end of a sentence. The data extraction module 104 is further configured to generate phrases from the plurality of sentences. The process of breaking the sentences in to plurality of phrases will now be explained in conjunction with the description for FIG. 2.

FIG. 2 illustrates the phrase chunking of a sentence, in accordance with at least one embodiment. 202 is an original sentence as extracted from the text file by the data extraction module 104. The data extraction module 104 is further programmed to extract individual and meaningful phrases from a sentence on the basis of a first technique. In an embodiment, the first technique is implemented by the data extraction module 104. The data extraction module 104 recognizes phrases in the sentence 202 by identifying the various ‘parts of speech’ in the sentence 202. For example, in an embodiment, the data extraction module 104 identifies the nouns, verbs, and prepositions in the sentence 202 to break the sentence 202 in to uniform and meaningful phrases. 204 is the sentence 202 chunked in to various phrases. In 204, NP is the noun phrase, VP is the verb phrase, and PP is the preposition phrase. As can be seen from 204, the data extraction module 104 effectively generates meaningful phrases, which can be understood independently of the entire sentence. It will be understood and appreciated by a person having ordinary skill in the art that any known technique can be used for splitting the text file in to a plurality of sentences without departing from the scope of the disclosed embodiments. In an embodiment, any known technique can be used for identifying phrases in the sentences without departing from the scope of the disclosed embodiments. Further, in an embodiment, the sentences and phrases extracted from the text file can be referred to as text snippets. It will be understood by a person having ordinary skill in the art that text snippets can be considered to be sub-parts of a sentence or the entire sentence itself.

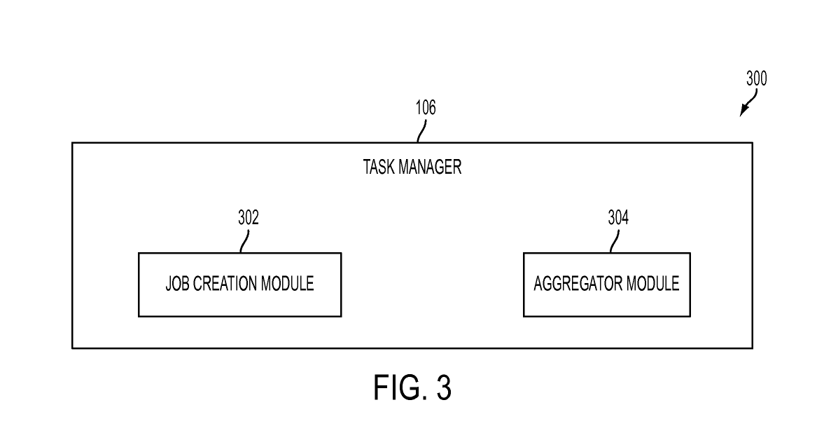

Referring again to system 100, system 100 further comprises a task manager 106. The phrases extracted from the sentences are sent by the data extraction module 104 to the task manager 106. The functionality of the task manager will now be discussed in conjunction with the detailed description for FIG. 3.

FIG. 3 illustrates components of a task manager, in accordance with at least one embodiment. The task manager 106 comprises a job creation module 302, an aggregator module 304, and a sampling filter 306.

Job creation module 302 is configured to create jobs. The created jobs are then distributed to the remote workers. In an embodiment, job creation module 302 prepares the tasks which are the published on a crowdsourcing platform from where it can be accessed by the remote workers. In an embodiment, Amazon's Mechanical Turk (MTurk) can be used for publishing the tasks. In another embodiment, CrowdFlower can be used for publishing the tasks. It will be understood by a person having ordinary skill in the art that any known crowdsourcing platform can be used for publishing the tasks without departing from the scope of the disclosed embodiments. In an embodiment, remote workers can access the task, view details about the task, and choose to complete the task for a fee. It will be understood by a person having ordinary skill in the art that the fee for the remote workers can be decided by an administrator of the crowdsourcing platform.

In an embodiment, the data extraction module 104 sends the extracted phrases to the job creation module 302. The job creation module 302 publishes the extracted phrases (in the source language) as a task on a crowdsourcing platform. The job creation module 302, specifies in the task, the target language to which the given phrases are required to be translated. The first set of remote workers access the task and complete the same. The responses submitted by the first set of remote workers comprise the translated versions of the phrases, which are henceforth referred to as translated phrases. In an embodiment, the translated phrases (responses from the remote workers) are received by the aggregator module 304.

In an embodiment, job creation module 302 is further configured to screen the responses submitted by the first set of remote workers for accuracy in accordance with a first pre-defined criteria. In an embodiment, a set of phrases in a source language for which translation is known (hereinafter referred to as a known set of phrases) with certainty is included in the set of extracted phrases which are published for translation. Responses from only those remote workers are accepted who have submitted correct translations for the known set of phrases. It will be appreciated by a person having ordinary skill in the art that the first pre-defined criteria acts as an initial filter in order to ensure that translation of phrases are accepted only from those remote workers who have established a level of credibility by correctly translating the known phrases.

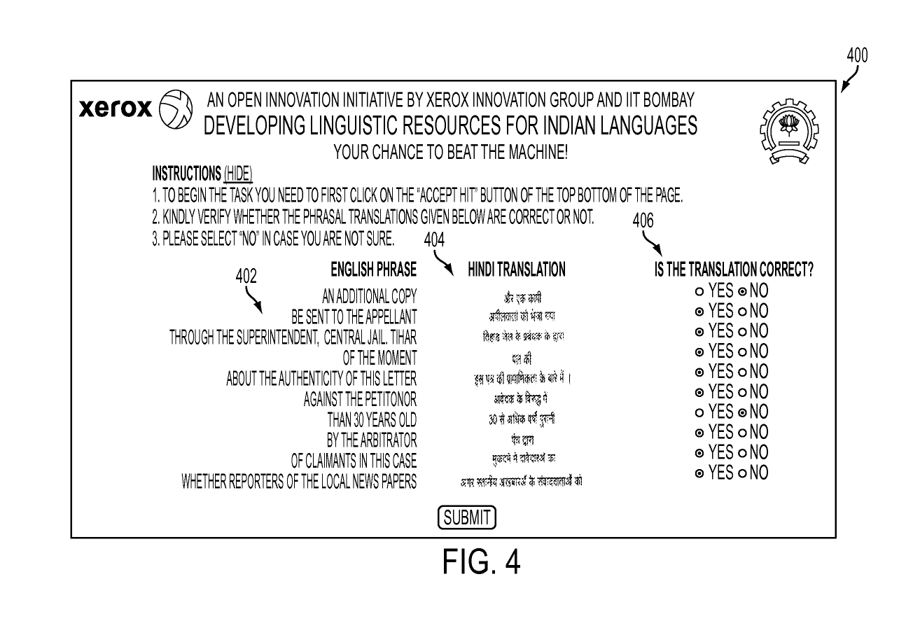

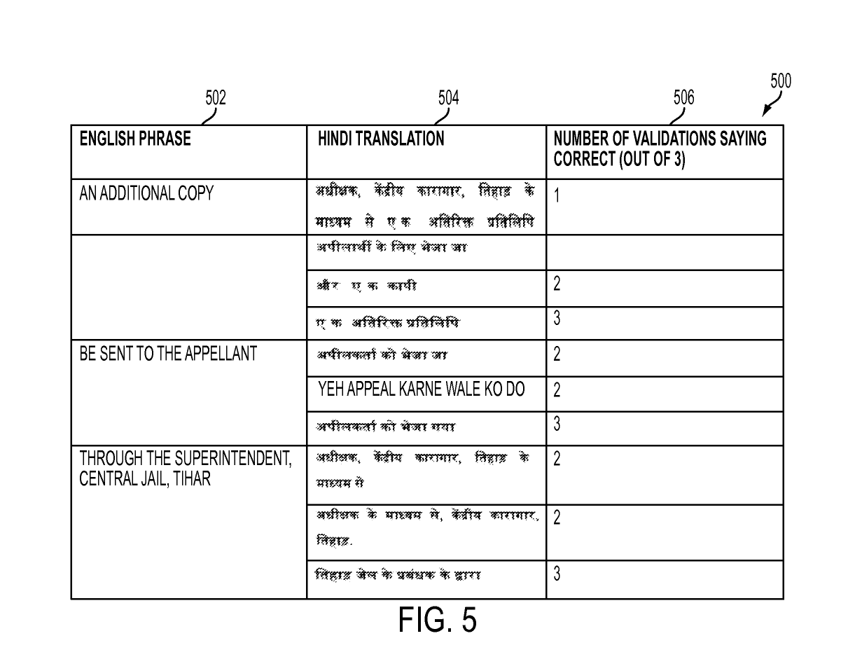

In an embodiment, the translated phrases are subjected to a second level of validation. It will be understood by a person having ordinary skill in the art that the translated phrases, although they have been received from a credible set of workers from the first set of remote workers, may still contain errors. In the second level of validation, job creation module 302 creates a second task for a second set of remote workers. In an embodiment, no remote worker from the first set of remote workers can be a part of the second set of remote workers. The second level of validation will now be explained in more detail in conjunction with FIG. 4 and FIG. 5.

FIG. 4 is a snapshot depicting the second task, in accordance with at least one embodiment. In an embodiment, job creation module 302 creates a second task in which the translated phrases are published on the crowdsourcing platform and a second set of remote workers are asked to validate if the translated phrases are correct. In an embodiment, for the second task, the job creation module 302 lists the phrases in the source language in a column 402. The translated phrases corresponding to the source language phrases are provided in a column 404. The second set of remote workers is provided with options to respond if a given translation is correct or not in a column 406. In accordance with an embodiment, the second set of remote workers are presented with ‘Yes’ or ‘No’ options in column 406 to validate if a given translation is correct or not. The compilation of responses received from the second set of remote workers and short-listing the correct translated phrases will now be explained in conjunction with the explanation for FIG. 5.

FIG. 5 is a screenshot depicting compilation of the responses for the second task in accordance with at least one embodiment. A column 502 lists the phrases in the source language. A column 504 lists the translated phrases in the target language and a column 506 lists the number of positive responses received from the second set of remote workers. In an embodiment, the responses from the second set of remote workers are received by the aggregation module 304.

In an embodiment, the aggregation module 304 is configured to aggregate the responses received from the second set of remote workers and present them in a table 500 along with the original and the translated phrases.

The translation for which maximum number of workers, from the second set of remote workers, provide confirmation will finally be considered as an accurate translation of the original phrase. In an embodiment, aggregator module 304 receives the responses from the second set of remote workers. In an embodiment, the aggregator module 304 is further configured to short-list translated phrases, which have received the maximum positive responses from the second set of remote workers.

The aggregator module 304 sends the short-listed translated phrases to job creation module 302. Referring to FIG. 1, the short-listed phrases are also sent by task manager 106 to repository 108. Repository 108 stores the translated phrases and these translations can later be re-used.

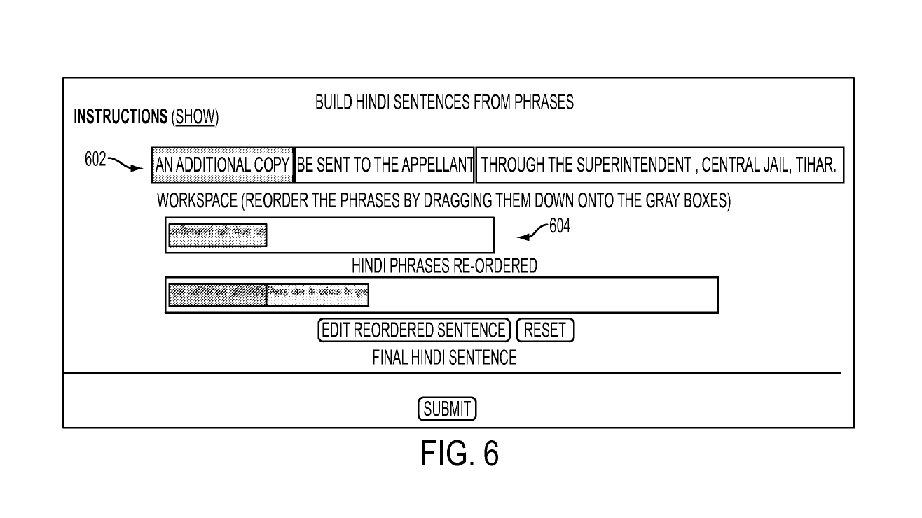

In an embodiment, the job creation module 304 is configured to create a third task for a third set of remote workers. The third task will now be explained in conjunction with the explanation for FIG. 6.

FIG. 6 is a screenshot depicting compilation of validated phrases in accordance with at least one embodiment.

In an embodiment, a third set of remote workers are tasked with compiling the translated, validated phrases in accordance with the original sentence in the source language. As can be seen from FIG. 6, a row 602 represents original sentence in the source language. In an embodiment, a row 604 is provided to the third set of remote workers where they can re-order the translated phrases in the target language in accordance with the grammar of the source language sentence. On the basis of the re-ordered translated phrases, a sentence in the target language is generated. In an embodiment, the third set of remote workers are also given the task of reordering the translated phrases and combining them to generate the final translated sentence.

It will be appreciated by a person having ordinary skill in the art that the final composed sentence in the target language can be subjected to an additional round of verification. In an embodiment, verification of the final sentence can be performed by a machine translation system. In another embodiment, the final sentence verification can be performed by a fourth set of remote workers. It will be understood be a person having ordinary skill in the art that the additional round of verification can be completed without departing from the scope of the present disclosure.

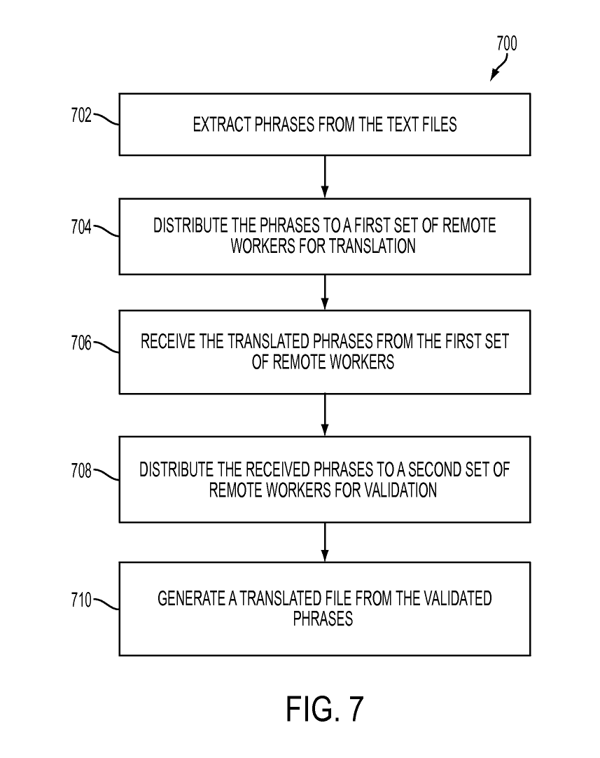

FIG. 7 is a flowchart illustrating a method of crowdsourcing translation services in accordance with at least one embodiment.

At 702, phrases are extracted from a text file. In an embodiment, sentences are extracted from the text file on the basis of the punctuation marks included in the text file. The process of extracting sentences and converting the same to meaningful phrases has been discussed in detail in the description for the preceding drawings. The extracted phrases are distributed for translation to a first set of remote workers at 704. At 706, the translated phrases are received from the first set of remote workers. In an embodiment, the translated phrases are received from the first set of remote workers in accordance with a first pre-defined criterion. The first pre-defined criterion is the determination of credible remote workers in the first set of remote workers. At 708, the translated phrases are distributed to a second set of remote workers for validation. In an embodiment, no remote worker from the first set of remote workers is part of the second set of remote workers. The validated phrases are finally used to construct a translated file in the target language at 710. The steps involved in the translation of phrases, validation of translated phrases, and construction of the translated file has been explained in detail in conjunction with the explanation for FIGS. 1-6.

The disclosed methods and systems, as described in the ongoing description or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be other similar means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information as desired. The storage element may be in the form of an information source or a physical memory element present in the processing machine.

The programmable or computer readable instructions may include various commands that instruct the processing machine to perform specific tasks, such as, the steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to ‘C’, ‘C++’, ‘Visual C++’ and ‘Visual Basic’. Further, the software may be in the form of a collection of separate programs, a program module with a larger program or a portion of a program module, as in the disclosure. The software may also include modular programming in the form of object-oriented programming. The processing of input data by the processing machine may be in response to user commands, results of previous processing or a request made by another processing machine. The disclosure can also be implemented in all operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, with the product capable of implementing the above methods and systems, or the numerous possible variations thereof.

The method, system, and computer code disclosed above have numerous advantages. It will be appreciated by a person having ordinary skill in the art that the above disclosed embodiments will facilitate the creation of Translation Memories (TMs) at a rapid and scalable pace. The process of getting phrases translated from remote workers not only affords price reduction of translation services, but also helps in the creation of a database with translation for individual phrases. Phrases are small parts of a sentence and as such will be repeated multiple times in a document. The stored translations can thus be re-used saving time and money. It will be appreciated that the easy availability of TMs will greatly aid the development of machine translation tools. It will also be understood by a person having ordinary skills in the art that the proposed embodiments are language independent and offer an economical method of translating voluminous documents in source languages in a short period of time.

It will be appreciated by a person skilled in the art that the system, modules, and sub-modules have been illustrated and explained to serve as examples and should not be considered limiting in any manner. It will be appreciated that the variants of the above disclosed system elements, or modules and other features and functions, or alternatives thereof, may be combined to create many other different systems or applications.

Those skilled in the art will appreciate that any of the foregoing steps and/or system modules may be suitably replaced, reordered, or removed, and additional steps and/or system modules may be inserted, depending on the needs of a particular application, and that the systems of the foregoing embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

What is claimed is:

1. A method for translating a text file, the method comprising:
extracting a plurality of text snippets from the text file;
distributing the plurality of text snippets to a first set of remote workers for translation;
receiving the translated text snippets from the first set of remote workers;
distributing the received text snippets to a second set of remote workers for validation; and
generating a translated file by combining the validated text snippets by a third set of remote workers.

2. The method of claim 1, wherein the generating comprises reordering and re-combining the validated text snippets to construct the translated text file.

3. The method of claim 1 further comprising storing the translated text file in a repository.

4. The method of claim 3 further comprising extracting the plurality of text snippets from the text file on the basis of a first predefined technique.

5. The method of claim 1, wherein the distributing the plurality of text snippets comprises creating a translation task for the first set of remote workers.

6. The method of claim 1, wherein receiving the translated text snippets comprises creating a validation task for the second set of remote workers.

7. The method of claim 1, wherein the translated text snippets are received on the basis of a first pre-defined criterion.

8. The method of claim 1, wherein the translated file is composed by a third set of remote workers.

9. A system for translating a text file, the system comprising:
a transceiver module for receiving the text file;
a data extraction module for extracting text snippets from the text file; and
a task manager for distributing the text snippets for translation, the task manager further comprising:
a job creation module for creating a translation and a validation task;
an aggregator for collecting responses for the translation and validation tasks.

10. The system of claim 9, wherein the task manager further comprises a sampling filter for verifying accuracy of the validated task.

11. The system of claim 9, wherein the job creation module is further configured to distribute the validated text snippets to a third set of remote workers.

12. The system of claim 9, wherein the transceiver is further configured to receive re-ordered validated text snippets from the third set of remote workers.

13. A computer program product for use with a computer, the computer program product comprising a computer readable program code embodied therein for translating a text file, the computer readable program code comprising:
program instruction means for extracting a plurality of text snippets from the text file;
program instruction means for distributing the plurality of text snippets to a first set of remote workers for translation;
program instruction means for receiving the translated text snippets from the first set of remote workers;
program instruction means for distributing the received text snippets to a second set of remote workers for validation; and
program instruction means for generating a translated file from the validated text snippets.

14. The computer program product of claim 13 further comprising program instruction means for creating a translation task for the first set of remote workers.

15. The computer program product of claim 13 further comprising program instruction means for storing the translated file in a repository.

16. The computer program product of claim 13 further comprising program instruction means for creating a validation task for the second set of remote workers.
